(19) United States
(12) Patent Application Publication
(10) Pub. No.: US 2014/0239632 A1
(43) Pub. Date: Aug. 28, 2014

(54) Connecting System for Adjacent Ends of Insulation Tubing

(71) Applicant: Aeroflex USA, Inc., Sweetwater, TN (US)

(72) Inventors: Brad Steverson, Lenoir City, TN (US); Greg Ertel, Clinton, TN (US); Darrell Peil, Rock Hill, SC (US)

(73) Assignee: Aeroflex USA, Inc., Sweetwater, TN (US)

(21) Appl. No.: 13/774,497

(22) Filed: Feb. 22, 2013

(51) Int. Cl. F16L 13/10; B29C 65/50

(52) U.S. Cl. CPC F16L 13/103; B29C 65/5064
USPC 285/285.1; 156/250; 156/249; 156/538

(57) ABSTRACT

A system and method to make stacked connector members for readily joining adjacent ends of sections of insulation tubing. Each of the stacked connector members includes a carrier member having a central opening. A layer of double-sided adhesive material is coated on each side of the carrier member, such that one side of the layer of double-sided adhesive material is able to bond to an end face of one section of insulation tubing, and the other side of the layer of double-sided adhesive material is able to bond to an end face of the second section of insulation tubing. In some embodiments, the layer of double-sided adhesive includes a scrim that acts as a reinforcing structure to keep the layer of double-sided adhesive material intact as a single body during and after application between two adjacent sections of insulation tubing.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

The present invention relates generally to systems and methods for joining adjacent ends of sections of insulation tubing and jackets for pipes.

2. Description of the Related Art

Thermal insulation for pipes is known in the art. Insulation tubing is used for pipes and fittings that convey steam, hot materials, condensate, lubricants, cryogenic fluids and cold materials typically used in heating and air conditioning, power facilities, food processing facilities and petrochemical facilities. Whereas cryogenic fluids approach absolute zero, steam for use in power production may range in temperature between 270° F. and 300° F., and can in some cases be much hotter. These temperatures will easily burn an individual should they come in contact with either of these materials or the piping transporting such materials or steam. Thus, insulation tubing is employed in a wide array of industrial applications, such as boilers and petrochemical plants.

Insulation tubing generally must be applied in sections. A problem arises of how to ensure a stable connection between two adjacent sections of insulation tubing, both to minimize temperature leaks and for safety purposes.

### BRIEF SUMMARY OF THE INVENTION

The present invention in some of its embodiments includes a carrier member and a double-sided adhesive attached to one side of the carrier member. The carrier member with double-sided adhesive is then stacked on the non-adhesive-bearing side of another carrier member. The number of carrier members in a stack can be as many as two and higher. This stack allows for a peeling of one carrier member away from the stack of carrier members; the one carrier member is then attached to an end face of one section of insulation tubing (or tube). Once applied, the carrier is then pulled away from the tube, leaving an end face of tube with double-sided adhesive attached to it. The carrier is then disposed of The end face of tube can then be adhered to another end face of tube with the same procedure applied, or to another end face of tube without double-sided adhesive.

In some embodiments of the present general inventive concept, a system to join adjacent ends of insulation tubing comprises a stack of a connector members, each connector member including a carrier member and a layer of double-sided adhesive material, each said carrier member in said stack separated from adjacent carrier members in said stack by layers of double-sided adhesive material, each said carrier member being coated with a layer of double-sided adhesive material, such that when a carrier member is detached from said stack, said carrier member transports with itself a layer of double-sided adhesive material, said layer of double-sided adhesive material to bond to insulation tubing, whereby when said layer of double-sided adhesive material is positioned between a first section of insulation tubing and a second section of insulation tubing, one side of said layer of double-sided adhesive material bonds to the first section of insulation tubing and another side of said layer of double-sided adhesive material bonds to the second section of insulation tubing. In some embodiments, both sections of insulation tubing have a layer of double-sided adhesive material applied before the two sections of insulation tubing are joined. In some embodiments, said layer of double-sided adhesive material includes a scrim to reinforce the layer of double-sided adhesive material. In some embodiments, said layer of double-sided adhesive material includes an acrylic-based double-sided adhesive material. In some embodiments, said layer of double-sided adhesive material includes a double-sided adhesive material fabricated from a thermoplastic rubber. In some embodiments, said layer of double-sided sided adhesive material includes a double-sided adhesive material fabricated from a pressure-sensitive polymer.

Some embodiments of the present general inventive concept comprise a method of fabricating stacked connector members to join adjacent ends of insulation tubing, said method comprising: supplying a plurality of sheets of carrier material; supplying a plurality of layers of double-sided adhesive material; forming a laminar body comprising alternating sheets of carrier material and layers of double-sided adhesive material; and cutting from said laminar body of a stack of carrier members and layers of double-sided adhesive material, each said carrier member being coated with a layer of double-sided adhesive material and each said carrier member in said stack separated from adjacent carrier members in said stack by layers of double-sided adhesive material. In some embodiments, said layer of double-sided adhesive material includes a scrim to reinforce the layer of double-sided adhesive material. In some embodiments, said layer of double-sided adhesive material includes at least one double-sided adhesive material selected from the group consisting of an acrylic-based double-sided adhesive material, a double-sided adhesive material fabricated from a thermoplastic rubber, and a double-sided adhesive material fabricated from a pressure-sensitive polymer.

Some embodiments of the present general inventive concept include a connector member to join adjacent ends of insulation tubing, comprising a carrier member coated with a layer of double-sided adhesive material, said carrier member transporting with itself a layer of double-sided adhesive material, said layer of double-sided adhesive material to bond to insulation tubing, whereby when said layer of double-sided adhesive material is positioned between a first section of insulation tubing and a second section of insulation tubing, one side of said layer of double-sided adhesive material bonds to the first section of insulation tubing and another side of said layer of double-sided adhesive material bonds to the second section of insulation tubing. In some embodiments, said layer of double-sided adhesive material includes a scrim to reinforce the layer of double-sided adhesive material. In some embodiments, said layer of double-sided adhesive material includes an acrylic-based double-sided adhesive material. In some embodiments, said layer of double-sided adhesive material includes a double-sided adhesive material fabricated from a thermoplastic rubber. In some embodiments, said layer of double-sided adhesive material includes a double-sided adhesive material fabricated from a pressure-sensitive polymer.

In some of the example embodiments, a stack of carriers, with inter-carrier layers of double-sided adhesive material, facilitates the speedy and efficient application of layers of double-sided adhesive material to join adjacent sections of insulation tubing. As each carrier is removed from the stack, said carrier transports with it a layer of double-sided adhesive material, which is applied between two adjacent sections of insulation tubing. The double-sided adhesive material adheres to the section of insulation tubing, and the remaining carrier is discarded. The next carrier in the stack is then ready to be removed from the stack, and the process of applying the layer of double-sided adhesive material between two adjacent sections of insulation tubing is repeated. The stack configuration facilitates the quick application of double-sided adhesive material.

In some embodiments, a method of applying a double-sided adhesive for connecting adjacent ends of insulation tubing includes peeling a first carrier member away from a stack of carrier members, said first carrier member carrying a layer of double-sided adhesive, attaching said first carrier member to an end face of a first section of insulation tubing, and pulling the carrier member away from the tube, whereby said layer of double-sided adhesive remains attached to the end face of the first section of insulation tubing. In some cases, the method includes peeling a second carrier member away from said stack of carrier members, said second carrier member carrying a layer of double-sided adhesive, attaching said second carrier member to an end face of a second section of insulation tubing, pulling the carrier member away from the tube, whereby said layer of double-sided adhesive remains attached to the end face of the first section of insulation tubing, and joining the end face of the first section of insulation tubing to the end face of the second section of insulation tubing, such that said layer of double-sided adhesive from said first carrier connects with said layer of double-sided adhesive from said second carrier between the first section of insulation tubing and the second section of insulation tubing.

### BRIEF DESCRIPTION OF THE SEVERAL VIEWS OF THE DRAWINGS

The above-mentioned and additional features of the invention will become more clearly understood from the following detailed description of the invention read together with the drawings in which:

FIG. 1 is an exploded view of a laminar body including a plurality of sheets of carrier material coated with layers of double-sided adhesive material;

FIG. 2 is a perspective view of the laminar body shown in FIG. 1, showing stacks of carrier members and layers of double-sided adhesive material being cut from the laminar body;

FIG. 3 is a perspective view of a stack of carrier members and layers of double-sided adhesive material;

FIG. 4A is a view of one part of the process of applying a layers of double-sided adhesive material according to the present general inventive concept, showing the detachment of one carrier and an attached layer of double-sided adhesive material from the stack;

FIG. 4B is a view of another part of the process of applying a layers of double-sided adhesive material according to the present general inventive concept, showing the orientation of the carrier proximate a section of insulation tubing;

FIG. 4C is a view of one part of the process of applying a layers of double-sided adhesive material according to the present general inventive concept, showing the carrier being peeled away from the section of insulation tubing, leaving the layer of double-sided adhesive material on the section of insulation tubing;

FIG. 4D is a view of one part of the process of applying a layers of double-sided adhesive material according to the present general inventive concept, showing the joinder of two sections of insulation tubing with the layer of double-sided adhesive material between them;

FIG. 5A is a perspective view of a carrier members and attached layer of double-sided adhesive material; and

FIG. 5B is a perspective view of a carrier members and attached layer of double-sided adhesive material with scrim.

### DETAILED DESCRIPTION OF THE INVENTION

The present invention in some of its embodiments is directed toward a system and method to make stacked connector members for readily joining adjacent ends of sections of insulation tubing. Each of the stacked connector members includes a carrier member having a central opening. A layer of double-sided adhesive material is coated on each side of the carrier member, such that one side of the layer of double-sided adhesive material is able to bond to an end face of one section of insulation tubing, and the other side of the layer of double-sided adhesive material is able to bond to an end face of the second section of insulation tubing.

In some of the several example embodiments, the present general inventive concept comprises a layer of double-sided adhesive to position between adjacent ends of neighboring pieces of insulation tubing. In some embodiments, the layer of double-sided adhesive includes a scrim that acts as a reinforcing structure to keep the layer of double-sided adhesive material intact as a single body during and after application between two adjacent sections of insulation tubing.

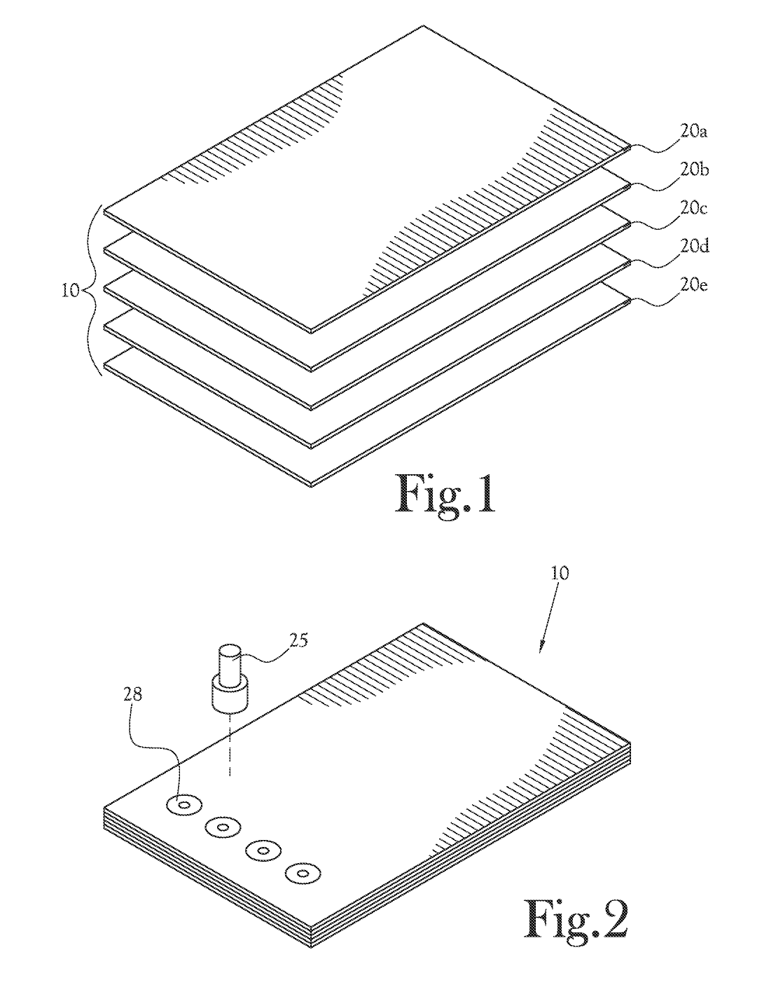

Turning to the Figures, FIG. 1 shows an exploded view of a laminate body involved in the manufacture of a stack of carriers according to one example embodiment of the present general inventive concept. As shown in FIG. 1, the laminate body 10 includes a plurality of sheet layers 20a-e of carrier material. Generally, a layer of double-sided adhesive material is interposed between each sheet layer 20a-e, resulting in a laminar body 10 shown in FIG. 2. As shown in FIG. 2, in a subsequent phase of the manufacturing process, a punch 25 is used to carve from the laminar body a stack 28 of substantially disc-like carrier members with double-sided adhesive material between each carrier member. FIG. 3 illustrates one example embodiment of a stack 28 of carrier members, each carrier member having a central opening; as a result of the manufacturing process, double-sided adhesive material is positioned between each carrier member (for example, between the top-most carrier member 30 and the next carrier member 30′ in the illustrated example embodiment). FIG. 3 further indicates an outboard or top-facing surface 34 of the top-most carrier member 30; generally, this outboard surface 34 is free of double-sided adhesive material.

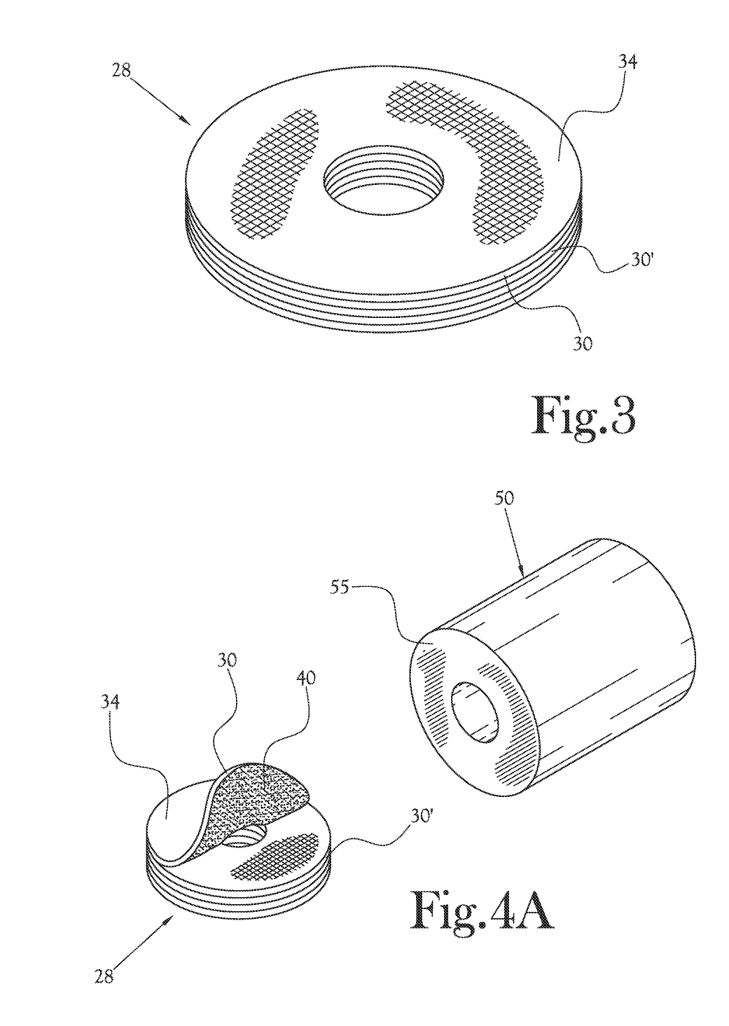

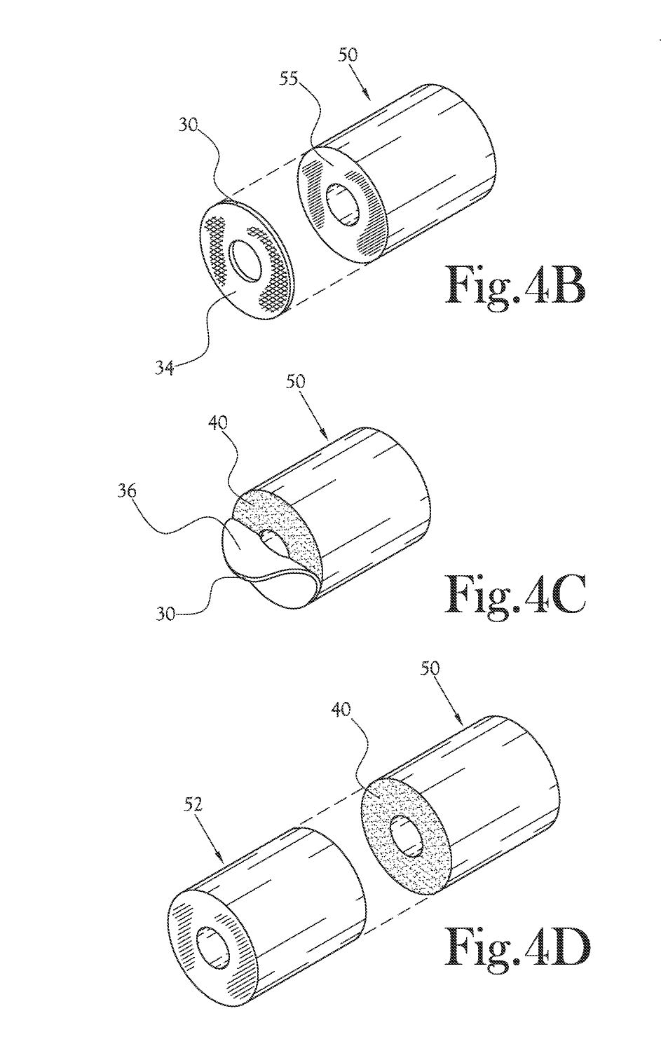

FIG. 4A through 4D illustrate one example embodiment of a method of using a carrier member with double-sided adhesive material to apply double-sided adhesive material to a section of insulation tubing. The illustrated example embodiment method also demonstrates some of the advantages of the present general inventive concept. As shown in FIG. 4A, the top-most or first carrier member 30 of the stack 28 is peeled away from the second carrier member 30′ immediately below the first carrier member 30. When the first carrier member 30 is peeled away from the stack 28, a layer of double-sided adhesive material 40 remains attached to the first carrier member 30; previous to the peeling away of the first carrier member 30 from the stack 28, the layer of double-sided adhesive material 40 resided between the first carrier member 30 and the second carrier member 30′. Once the first carrier member 30 has been fully detached from the stack 28, the first carrier member 30 is moved into position near a section of insulation tubing 50, as shown in FIG. 4B. The section of insulation tubing 50 includes an end face 55, where the layer of double-sided adhesive material 40 is to be applied. As shown in FIG. 4C, the first carrier 30 is abutted to the end face 55 of the section of insulation tubing 55, such that the layer of double-sided adhesive material 40 substantially covers and is in physical contact with the end face 55. The first carrier 30 is then moved away from the end face 55 of the section of insulation tubing 50, while the layer of double-sided adhesive material 40 remains deposited on the end face 55 of the section of insulation tubing 50. Next, as shown in FIG. 4D, a second section of insulation tubing 52 is moved into a position such that an end face of the second section of insulation tubing 52 is directly opposing and substantially adjacent to the end face 55 of the first section of insulation tubing 50, with the layer of double-sided adhesive material 40 between the two end faces. The layer of double-sided adhesive material 40 thereby adheres to the two proximate end faces of both sections of insulation tubing 50 and 52.

Thus, in the illustrated example embodiment, and in other example embodiments of the present general inventive concept, a stack of carriers, with inter-carrier layers of double-sided adhesive material, facilitates the speedy and efficient application of layers of double-sided adhesive material to join adjacent sections of insulation tubing. As each carrier is removed from the stack, said carrier transports with it a layer of double-sided adhesive material, which is applied between two adjacent sections of insulation tubing. The next carrier in the stack is then ready to be removed from the stack, and the process of applying the layer of double-sided adhesive material between two adjacent sections of insulation tubing is repeated. The stack configuration facilitates the quick application of double-sided adhesive material. In various embodiments, carriers may be peeled from the top of the stack or from the bottom of the stack.

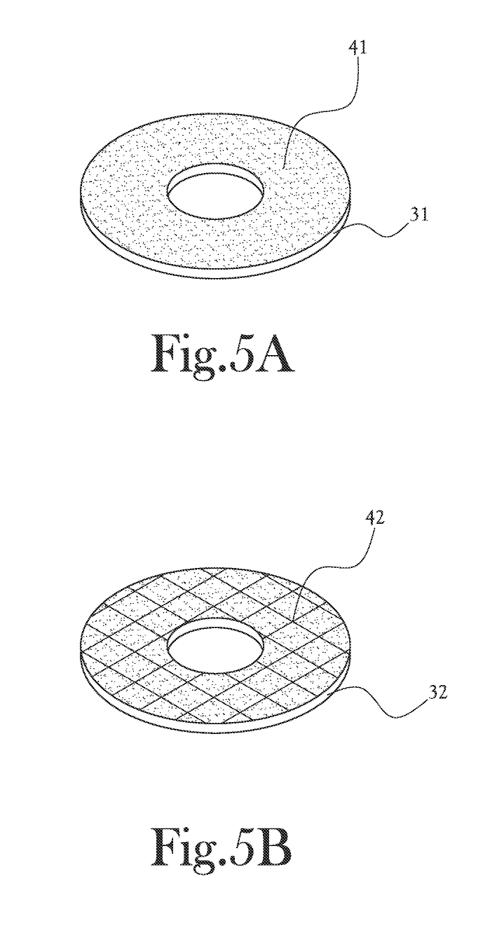

In some example embodiments of the present general inventive concept, such as that shown in FIG. 5A, the carrier 31 includes a layer of double-sided adhesive material 41 that includes no scrim or reinforcing structure within the layer of double-sided adhesive material 41 itself In some example embodiments, such as that shown in FIG. 5B, the carrier 32 includes a layer of double-sided adhesive material 42 that does include a scrim or other reinforcing structure within the layer of double-sided adhesive material 42 itself In these embodiments, the scrim or reinforcing structure generally comprises a fine, lightweight material worked in a criss-crossed pattern and in close contact with or surrounded by the double-sided adhesive material. Generally, the criss-crossed pattern of the scrim leaves substantial apertures allowing the free through-penetration of double-sided adhesive material, while still performing a reinforcing function and helping to keep the double-sided adhesive material together in a single body.

In some embodiments, the double-sided adhesive material is an acrylic-based pressure-sensitive double-sided adhesive. In some embodiments, the double-sided adhesive material is based on a thermoplastic rubber or similar polymer. Those of skill in the art will recognize that other double-sided adhesive materials will be suitable, and that the present general inventive concept is not limited to any particular double-sided adhesive material or any single class of double-sided adhesive materials.

Thus, some embodiments of the present general inventive concept include a connector member to join adjacent ends of insulation tubing, comprising a carrier member coated with a layer of double-sided adhesive material, said carrier member having a central opening. Said carrier member transports with itself a layer of double-sided adhesive material, said layer of double-sided adhesive material to bond to insulation tubing. When said layer of double-sided adhesive material is positioned between a first section of insulation tubing and a second section of insulation tubing, one side of said layer of double-sided adhesive material bonds to the first section of insulation tubing and another side of said layer of double-sided adhesive material bonds to the second section of insulation tubing. In several embodiments, the carrier member can include a split extending from the center opening to the outer edge. In some embodiments, said layer of double-sided adhesive material includes a scrim to reinforce the layer of double-sided adhesive material. In some embodiments, said layer of double-sided adhesive material includes an acrylic-based double-sided adhesive material. In some embodiments, said layer of double-sided adhesive material includes a double-sided adhesive material fabricated from a thermoplastic rubber. In some embodiments, said layer of double-sided adhesive material includes a double-sided adhesive material fabricated from a pressure-sensitive polymer. The present general inventive concept is not limited to any particular adhesive material or any single class of adhesive materials, and other double-sided adhesive materials may be suitable in some embodiments.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A system configured to join adjacent ends of insulation tubing, comprising:
a stack of a connector members, each connector member including a carrier member and a layer of double-sided adhesive material, each said carrier member in said stack separated from adjacent carrier members in said stack by layers of double-sided adhesive material, each said carrier member being coated with a layer of double-sided adhesive material, such that when a carrier member is detached from said stack, said carrier member transports with itself a layer of double-sided adhesive material,
said layer of double-sided adhesive material to bond to insulation tubing,
whereby when said layer of double-sided adhesive material is positioned between a first section of insulation tubing and a second section of insulation tubing, one side of said layer of double-sided adhesive material bonds to the first section of insulation tubing and another side of said layer of double-sided adhesive material bonds to the second section of insulation tubing.

2. The system of claim 1 wherein said layer of double-sided adhesive material includes a scrim to reinforce the layer of double-sided adhesive material.

3. The system of claim 1 wherein said layer of double-sided adhesive material includes an acrylic-based double-sided adhesive material.

4. The system of claim 1 wherein said layer of double-sided adhesive material includes an double-sided adhesive material fabricated from a thermoplastic rubber.

5. The system of claim 1 wherein said layer of double-sided adhesive material includes an double-sided adhesive material fabricated from a pressure-sensitive polymer.

6. A method of fabricating stacked connector members to join adjacent ends of insulation tubing, comprising:
supplying a plurality of sheets of carrier material;
supplying a plurality of layers of double-sided adhesive material;
forming a laminar body comprising alternating sheets of carrier material and layers of double-sided adhesive material; and
cutting from said laminar body a of a stack of carrier members and layers of double-sided adhesive material, each said carrier member being coated with a layer of double-sided adhesive material and each said carrier member in said stack separated from adjacent carrier members in said stack by layers of double-sided adhesive material.

7. The method of claim 6 wherein said layer of double-sided adhesive material includes a scrim to reinforce the layer of double-sided adhesive material.

8. The method of claim 6 wherein said layer of double-sided adhesive material includes at least one double-sided adhesive material selected from the group consisting of an acrylic-based double-sided adhesive material, a double-sided adhesive material fabricated from a thermoplastic rubber, and a double-sided adhesive material fabricated from a pressure-sensitive polymer.

9. A connector member to join adjacent ends of insulation tubing, comprising a carrier member coated with a layer of double-sided adhesive material, said carrier member transporting with itself a layer of double-sided adhesive material, said layer of double-sided adhesive material to bond to insulation tubing, whereby when said layer of double-sided adhesive material is positioned between a first section of insulation tubing and a second section of insulation tubing, one side of said layer of double-sided adhesive material bonds to the first section of insulation tubing and another side of said layer of double-sided adhesive material bonds to the second section of insulation tubing.

10. The connector member of claim 9 wherein said layer of double-sided adhesive material includes a scrim to reinforce the layer of double-sided adhesive material.

11. The connector member of claim 9 wherein said layer of double-sided adhesive material includes an acrylic-based double-sided adhesive material.

12. The connector member of claim 9 wherein said layer of double-sided adhesive material includes a double-sided adhesive material fabricated from a thermoplastic rubber.

13. The connector member of claim 9 wherein said layer of double-sided adhesive material includes a double-sided adhesive material fabricated from a pressure-sensitive polymer.

14. A method of applying a double-sided adhesive for connecting adjacent ends of insulation tubing, comprising:
peeling a first carrier member away from a stack of carrier members, said first carrier member carrying a layer of double-sided adhesive;
attaching said first carrier member to an end face of a first section of insulation tubing; and
pulling the carrier member away from the tube, whereby said layer of double-sided adhesive remains attached to the end face of the first section of insulation tubing.

15. The method of claim 14 further comprising:
peeling a second carrier member away from said stack of carrier members, said second carrier member carrying a layer of double-sided adhesive;
attaching said second carrier member to an end face of a second section of insulation tubing;
pulling the carrier member away from the tube, whereby said layer of double-sided adhesive remains attached to the end face of the first section of insulation tubing; and
joining the end face of the first section of insulation tubing to the end face of the second section of insulation tubing, such that said layer of double-sided adhesive from said first carrier connects with said layer of double-sided adhesive from said second carrier between the first section of insulation tubing and the second section of insulation tubing.
